(19) United States
(12) Patent Application Publication
(10) Pub. No.: US 2016/0253380 A1
(43) Pub. Date: Sep. 1, 2016

(54) DATABASE QUERY OPTIMIZATION

(71) Applicant: Red Hat, Inc., Raleigh, NC (US)

(72) Inventors: Filip Nguyen, Brno (CZ); Filip Elias, Vysni Lhoty (CZ)

(21) Appl. No.: 14/632,721

(22) Filed: Feb. 26, 2015

(51) Int. Cl. G06F 17/30

(52) U.S. Cl. CPC G06F 17/30442; G06F 17/30595; G06F 17/30867

(57) ABSTRACT

Various examples are directed to systems and methods for managing a database comprising data items from a constituent source. A federation engine may receive from a first client a first client query. The first client query may reference a data item stored at a constituent data source. The federation engine may determine that the first client query is a complex client query and send the first client query to an administrator system.

### BACKGROUND

Databases play an increasingly important role in modern life and business. Businesses have come to use databases in any number of different contexts. Human resource departments use databases to store data describing employees, including, compensation information, address information, etc. Sales and marketing departments use customer relationship management (CRM) databases to store data describing customers including, for example, purchases, product preferences, etc. Information technology (IT) departments use databases for many purposes including, for example, storing data describing computer devices, software applications, etc. Consumers too are becoming increasingly dependent on databases. For example, a typical computer device user may use a media application that maintains a database of available media files, a calendar or e-mail application that maintains a database of personal and/or business contacts, a financial application that maintains a database of financial records, and others.

### SUMMARY

Various examples are directed to systems and methods for managing a database comprising data items from a constituent source. A federation engine may receive from a first client a first client query. The first client query may reference a data item stored at a constituent data source. The federation engine may determine that the first client query is a complex client query and send the first client query to an administrator system.

### FIGURES

Various examples are described herein in conjunction with the following figures, wherein:

FIG. 1 is a diagram showing one example of an environment for optimizing client queries in a federated system.

FIG. 2 is a diagram showing one example of a hardware environment for implementing the various components of the environment of FIG. 1.

FIG. 3 is a flow chart showing one example of a process flow that may be executed in the environment to optimize queries.

FIG. 4 is a flow chart showing one example of a process flow that may be executed by a client and the federation engine to optimize complex queries as described herein.

FIG. 5 is a flow chart showing one example of a process flow 300 that may be executed by the federation engine 12 and the administrator system 18 to optimize complex queries as described herein.

### DESCRIPTION

Various examples described herein are directed to systems and methods for optimizing client queries in environments utilizing a federation engine. A federation engine, such as the JBOSS DATA VIRTUALIZATION product available from RED HAT, INC., may allow data from multiple databases, web servers, and other data sources to be aggregated and accessed through a common source (e.g., the federation engine). For example, the federation engine may implement a schema, where the records, tables, indices, etc. of the schema are populated from the data stored at the various constituent data sources. The federation engine may act as database management system (DBMS) that allows clients to make database queries against the aggregated data, as organized by the schema. The federation engine converts database queries received from clients into appropriate database or other queries directed to the constituent data sources. If necessary, the federation engine replies to the clients based on responses received from the constituent data sources.

Because the clients interact with the constituent data sources through the federation engine, the clients may not know the state(s) of the constituent data sources. Therefore, the clients may not optimize queries based on the current state of the data sources. This may lead to inefficient queries that consume excessive system resources. Examples of the federation engine described herein may be configured to optimize queries so as to improve efficiency.

Reference will now be made in detail to various examples, several of which are illustrated in the accompanying figures. Wherever practical, similar or like reference numbers may be used in the figures and may indicate similar or like functionality. The figures depict examples of the disclosed systems (or methods) for purposes of illustration only. One skilled in the art will readily recognize from the following description that alternative examples of the structures and methods illustrated herein may be employed without departing from the principles described herein.

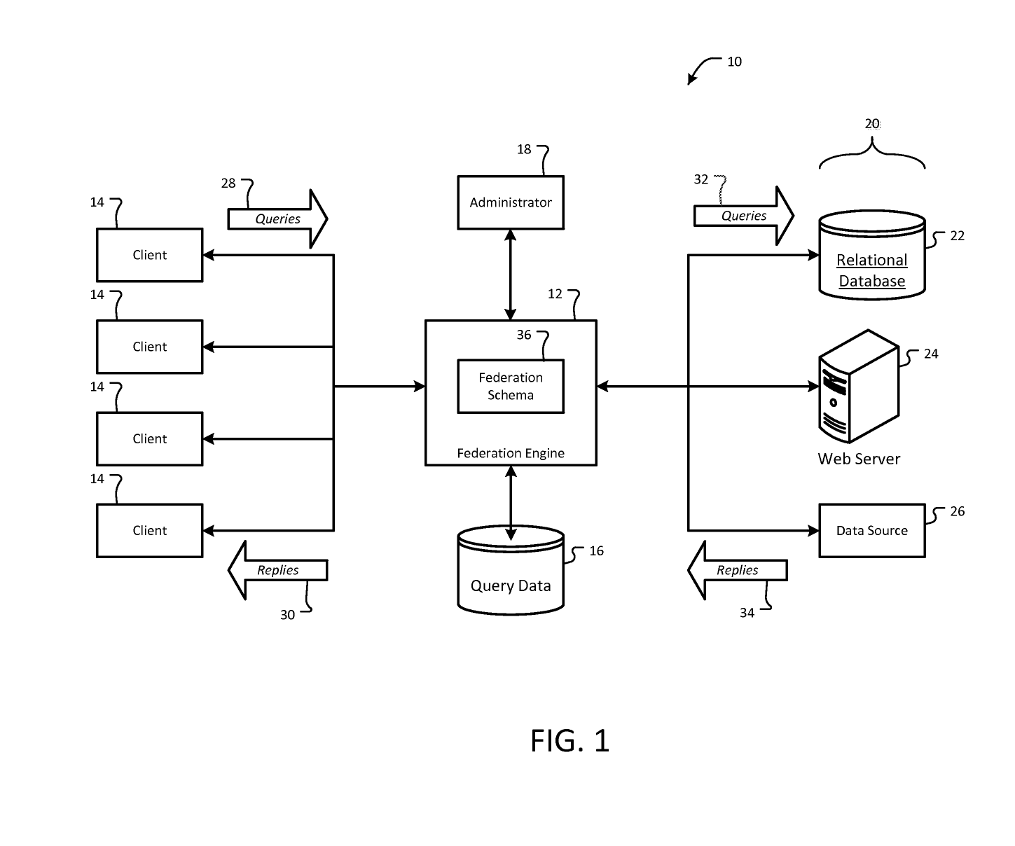

FIG. 1 is a diagram showing one example of a federation engine environment 10 configured for optimizing client queries with a federation engine 12. In addition to the federation engine 12, the environment 10 may comprise one or more clients 14, one or more constituent data sources 20, an administrator system 18, and a query data store 16. The federation engine 12 may be executed on any suitable computer system comprising any suitable computing device or devices. The federation engine 12 may implement a federation database schema or federation schema 36. A database schema is a description of the organization of records in the database. For example, many schemas define sets of related database objects including, records, tables, indices, etc. Database objects making up the federation schema 26 may be populated with records drawn from the constituent data sources 20, as described herein.

The federation engine 12 may act as a database management system (DBMS) that allows the clients 14 to make database queries for data aggregated from the constituent data sources 20 according to the federation schema 36. A DBMS is a software application that facilitates interaction between a database or databases and other components of the environment 10. For example, a DBMS may have an associated data definition language describing queries that may be executed to interact with the database. Examples of suitable DBMS's include MySQL, MariaDB, PostgreSQL, SQLite, Microsoft SQL Server available from the MICROSOFT CORPORATION, various DBMS's available from ORACLE CORPORATION, various DBMS's available from SAP AG, IBM DB2, available from THE INTERNATIONAL BUSINESS MACHINES CORPORATION, etc.

Clients 14 may be applications executed on any suitable computer system comprising any suitable computing device or devices. Clients 14 may direct client database queries 28 to the federation engine 12. Database queries may include various types of read requests and write requests. For example, a client 14 may send a client query 28 requesting one or more records from the federation schema 26. In another example, a client 14 may send a client query 28 requesting that a data item value be written to a particular table or column location at the federation schema 36. In yet another example, a client 14 may send a client query 28 commanding that a database object (e.g., table, row, column, etc.) be created and/or modified at the federation schema 26. In various examples, the client queries 28 may be according to a data definition language associated with the federation engine 12. In some examples, the data definition language is a structured query language (SQL) such as PL/SQL.

The federation engine 12 may receive client queries 28 and process the client queries 28 to generate federation engine queries 32 directed towards the constituent data sources 20. The federation engine queries 32 may request data from and/or modifications to the constituent data sources consistent with the client queries 28. The syntax and content of the federation engine queries 32 may be determined based on the nature of the constituent data source 20 to which they are directed. The constituent data sources 20 may include any suitable type of data source including, for example, relational databases 22, web servers, 24 or other data sources 26. Constituent data sources 20 may be executed on computing devices distinct from the computing device or devices executing the federation engine 12 and/or may be executed on the same computing device or devices executing the federation engine 12. Federation engine queries 32 directed to a relational database may be formatted according to the data definition language utilized by a DBMS associated with the database 22. Federation engine queries 32 directed to a web server 24 may be formatted according to a syntax expected by the web server 24. For example, federation engine queries 32 may comprise an account name, and one or more parameters identifying the requested data and/or action. In some examples, constituent data sources may include one or more cloud data storage systems such as, for example, systems available from THE MICROSOFT CORPORATION, AMAZON.COM, INC., RACKSPACE, INC., etc. Cloud storage systems may be accessed in any suitable manner. For example, the federation engine 12 may access a cloud storage system via an application program interface (API), via a web server, such as 24, and/or via a DBMS for a database, such as 22.

Constituent data sources 20 may optionally provide replies 34 to federation engine queries 32. Replies 32 may comprise, for example, requested data items or other requested data, confirmations that a requested change or changes have been made to an appropriate constituent data source 20, etc. The federation engine 12 may convert data received from the replies 34 and generate corresponding replies 30 that are directed to the various clients 14. The federation engine 12 may store data describing client queries 28, federation engine queries 32, replies 34, and/or replies 30 at the query data store 16. As described herein, the federation engine 12 may interact with the administrator system 18 to receive and implement optimized queries. The queries 28, 32 and replies 32, 34 may have any suitable relationship to one another. In one example, a single client 14 may direct at client query 28 to the federation engine 12. The federation engine 12, in turn, may direct one or more federation engine queries 32 to one or more constituent data sources 20. The federation engine 12 may receive one or more replies 34 from the constituent data source or sources 20. The replies 34 may be aggregated to generate a reply 30 that is directed to the client 14 that sent the original client query 14.

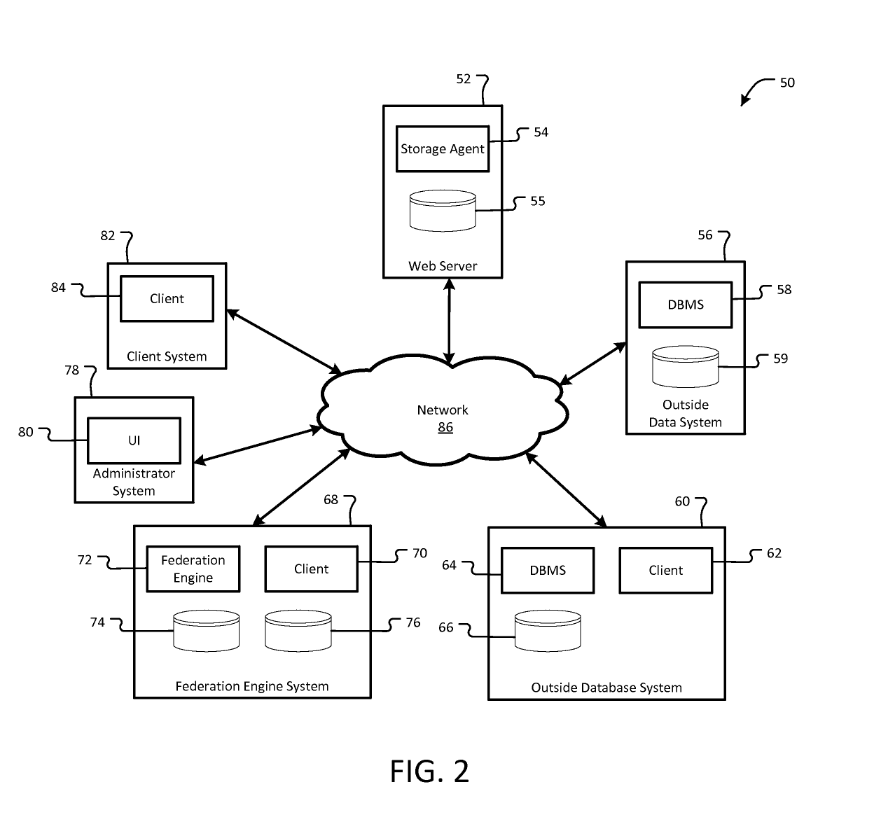

FIG. 2 is a diagram showing one example of a hardware environment 50 for implementing the various components of the environment 10 of FIG. 1. A federation engine system 68 may comprise one or more computing devices executing or comprising various components of the environment 10. For example, the federation engine system 68 may execution a federation engine 72. The federation engine system 68, in some examples, may also comprise a data store 74 which may comprise the query data 16 described above. In some examples, the federation engine system 68 may execute a client 70, which may act as one or more of the clients 14 described herein. Also, in some examples, the federation engine system 68 may comprise a data source 76 that may be one of the outside data sources 20 described herein. For example, the data source 76 may be a relational database. The federation engine 72 may act as the DBMS for the database.

An outside data source system 60 may also comprise one or more computing devices executing or comprising a DBMS 64 for a database 66. The database 66 may be among the outside data sources 20 described herein. In some examples, the outside data source system 60 may further execute a client 62, which may act as one of the clients 14 described herein. Another example outside data system 56 may similarly comprise one or more computing devices along with a database 59. The database 59 may act as one or more of the outside data sources 20 described herein. The outside data system 56 may execute a DBMS 58 for managing the database. A web server 52 may also comprise one or more computing devices. The web server 52 may comprise and/or be in communication with one or more data stores 55. A storage agent 54 executed by the web server 52 may receive and respond to queries. In this way the web server 52 may act as one or more of the outside data sources 20 described herein. In some examples, the web server 52 may also execute a client (not shown).

A stand-alone client system 82 may also comprise one or more computing devices. The client system 82 may execute a client 84, which may act as one or more of the clients 14 described herein. An administrator system 78 may comprise one or more computing devices. The administrator system 78 may execute a user interface (UI) 80 for receiving data and instructions from an administrator of the federation engine 72. In some examples, the administrator system 78 may be omitted and the UI 80 may be executed by the federation engine system 68. For example, a human administrator may interface with the federation engine system 68.

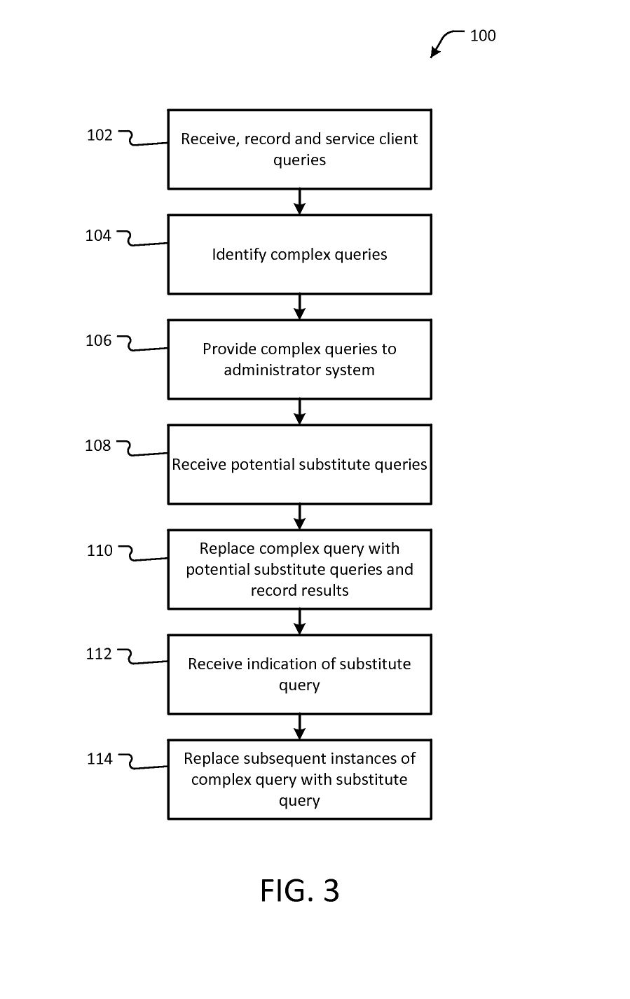

FIG. 3 is a flow chart showing one example of a process flow 100 that may be executed in the environment 10 to optimize queries. The process flow 100 may be executed, for example, by the federation engine 12 in the course of receiving and responding to client queries 28. At 102, the federation engine 102 may receive, record and service client queries 28, for example, as described herein with respect to FIG. 1. When the federation engine 12 receives a client query 28, it may record the query to the query data store 16 and generate a reply 30 to the query, for example, as described herein.

At 104, the federation engine 12 may identify a complex query from among received client queries 28. For example, because the clients 14 are not in direct communication with some or all of the constituent data sources 20, the clients 14 may not optimize the complexity of the client queries 28 based on the state of the constituent data stores 20. For example, some types of queries may always take a constant time to execute, regardless of the size of the database against which the queries are executed, while other queries have execution times that depend on the size of the database. To illustrate this concept, an example database table People is provided below:

People

PersonID
Person First Name
Person Last Name
Person Address
Person Phone Number

The table People, for example, may be part of the federation schema 36. One or more of the constituent data sources 20 may comprise a table equivalent to People or, in some examples, the federation engine 12 may create the table People from different data sources 20. One example client query 28 that may be made against the table People may be as follows:
SELECT * FROM People
   The reply 30 to this query may include all records in the table People. The size of the reply to this query and the amount of time and system resources necessary to create the reply may depend on the size of the table. On the other hand, another example client query 28 that may be made against the table People is as follows:
SELECT TOP n FROM People
   The reply 30 to this query may include the first n rows from the table People. The size of reply to this query and the amount of time and system resources necessary to create the reply may be constant, regardless of the size of the table.

The complexity of queries is sometimes expressed in “Big O” notation. Big O notation is indicated as shown in Equation (1) below:

O(f(n)) (1)

The order of f(n) may indicate the complexity of the query. When f(n) for a query is a constant (e.g., (O(1)), it indicates that the time to complete the query does not depend on the size of the table or database. When f(n) for a query is on the order of n (e.g., O(n)), then the time to complete the query is proportional to the number of records in the table or database. When f(n) is of a higher order (e.g., O(n^{x})), then the time to complete the query may be an exponential of the number or records in the table or database.

Referring back to 104, the federation engine 12 may identify complex queries in any suitable manner. In some examples, the federation engine 12 may identify as complex any client queries 28 with an execution time that depends on the number of records in a table or database (e.g., any query with a complexity greater than O(1)). Also, in some examples, the federation engine 12 may utilize a complexity threshold that depends on the size of the database and/or database table that is the subject of the query. For example, if the database table referenced by a query is smaller than a threshold size, the federation engine 12 may apply a higher complexity threshold before classifying a query as complex. One example of a table-size-dependent complexity threshold is given by TABLE 1 below:

TABLE 1

| Table Size | Complexity Threshold |
|---|---|
| Number of Records < X | O(n²) |
| X < Number of Records < Y | O(n) |
| Y < Number of Records | O(1) |

For example, as indicated in TABLE 1, when a query is directed to a table having X or fewer records, then queries with a complexity greater than O(n²) may be identified as complex. When a query is directed to a table having between X and Y records, queries with a complexity greater than O(n) may be identified as complex. When a query is directed to a table having more than Y records, then queries with a complexity greater than O(1) may be identified as complex. In some examples, when a client query 28 is identified as complex, that fact along with the query itself may be recorded to the query data store 16.

At 106, the federation engine 12 may provide to the administrator system 18 one or more queries identified at 104 as complex. The queries may be provided to the administrator system 18 in any suitable manner. In some examples, the administrator system 18 may have access to the query data store 16. Accordingly, providing complex queries to the administrator system 18 may comprise writing the complex queries to the query data store 16 at a location accessible t the administrator system 18. Also, in some examples, the federation engine 12 may transmit each complex query to the administrator system 18 as it is identified. Also, in some examples, the federation engine 12 may periodically transmit identified complex queries to the administrator system 18, for example, based on a period of time, a number of identified complex queries, etc.

The administrator system 18 may comprise a user interface (e.g., interface 80 in FIG. 2) or another suitable mechanism to provide the identified complex queries to an administrator (not shown). The administrator may propose substitute queries, e.g., a query or queries that would provide a result equivalent to the complex query albeit at a reduced complexity. Substitute queries may be generated in any suitable manner. In some examples, creating a substitute query may comprise adding objects to the federation schema 36. For example, a query requesting the number of rows in a table A may have a complexity of O(n) because responding to the query requires traversing every row of the table. To create a substitute query, the administrator may create a new table B or other data structure comprising a record R indicating the number of rows in table A. Every time a row is added to table A, the record R may be incremented. Accordingly, a substitute query for the complex query requesting the number of rows in table A may be replaced by a substitute query requesting the value of the record R. In complex systems, it may not always be possible to determine whether a substitute query will consistently outperform the original complex query.

At 108, the federation engine 12 may receive potential substitute queries from the administrator system 18. At 110, the federation engine 12 may randomly replace subsequent instances of complex queries with one of the received substitute queries. For example, if a client query 28 is receive that is the same as a client query 28 previously identified as complex, then the federation engine 12 may randomly replace the client query 28 with one of the received substitute queries. In some examples, the federation engine 12 may be programmed such that the complex query and each of the potential substitute queries may be processed about the same number of times. For example, the complex query and each of potential substitute query may have the same chance of being processed. Results of the execution of the complex query and the potential substitute queries may be stored at the query data store 16. The results may be transmitted to or otherwise made accessible to the administrator system 18, for example, as described herein with respect to 106.

At 112, the federation engine 12 may receive an indication of one or more selected substitute queries. For example, upon receiving the results described with respect to 110, an administrator may select the selected substitute query from among the potential substitute queries. For example, some or all of the complex queries identified at 104 may ultimately be assigned a selected substitute query at 112. At 114, the federation engine 12 may replace detected complex queries with selected substitute queries. For example, if an identified complex query has a selected substitute query, then the federation engine 12 may execute the selected substitute query instead of the requested complex query. In various examples, the process flow 100 may continue to be executed as more complex queries are received and identified. For example, as the size of a constituent data store 20 or table thereof increases, queries that were not previously considered complex may become complex. Also, in some examples, the federation engine 12 may continue to capture and store statistics describing the execution of selected substitute queries. This may allow the administrator to determine whether continued execution of the selected substitute query is most efficient.

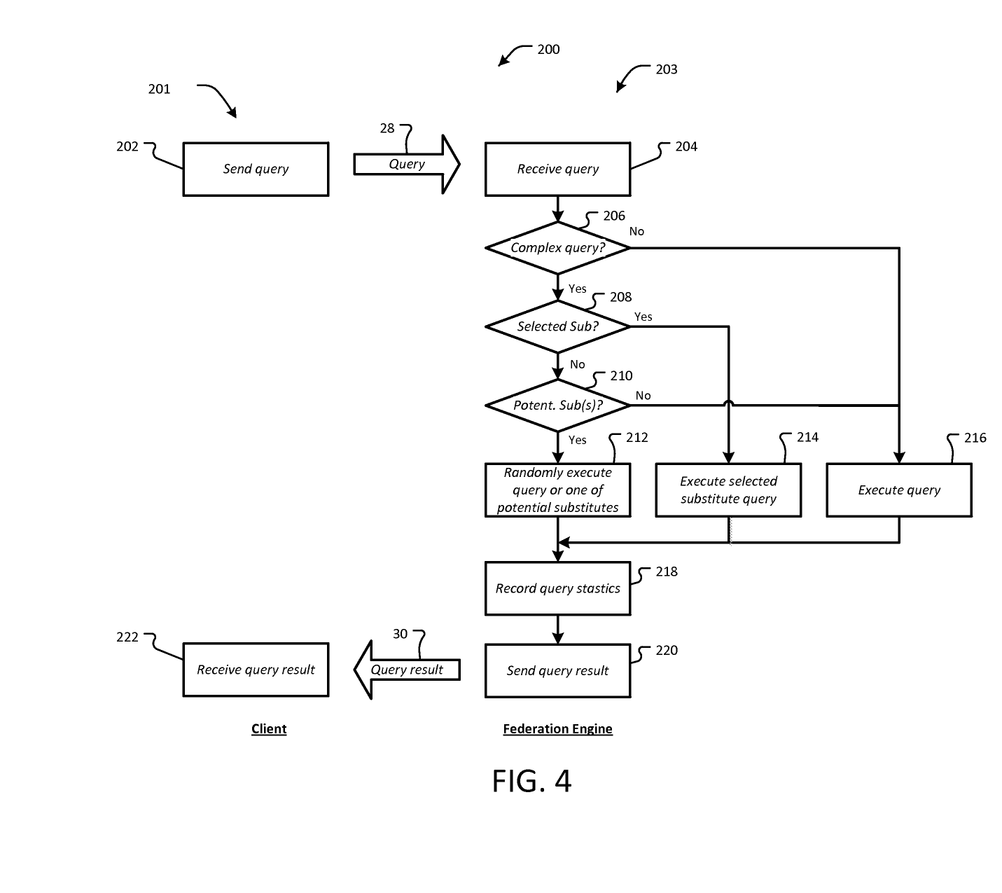

FIG. 4 is a flow chart showing one example of a process flow 200 that may be executed by a client 14 and the federation engine 12 to optimize complex queries as described herein. The process flow 200 comprises a first column 201 showing actions that may be executed by an example client 14 and a second column 203 showing actions that may be executed by the federation engine 12. At 202, the client 14 may send a client query 28 to the federation engine 12. The federation engine 12 may receive the client query 28 at 204. At 206, the federation engine 12 may determine whether the client query 28 is a complex query, for example, as described herein with respect to 102. If the client query 28 is not a complex query, the federation engine may execute the query at 216. Executing the client query 28 may involve sending one or more federation engine queries 32 to one or more of the constituent data sources 20, as described herein. At 218, the federation engine 12 may, optionally, record query statistics to the query data store 16. Query statistics may include, for example, a time required to execute the query or any other suitable statistics. At 220, the federation engine 12 may send a query result 30 to the client 14, which may receive the query result at 222.

If, at 206, the federation engine 12 determines that the client query 28 is a complex query, then it may determine at 208 whether the complex query has a previously determined selected substitute query. If so, then the federation engine may execute the selected substitute query at 214 and record statistics of the execution at 218. A query result 30, determined based on the selected substitute query, may be transmitted to the client 14 at 220 and received by the client 14 at 222.

If, at 208, the federation engine determines that the client query 28 does not have a previously determined selected substitute query, then it may determine at 210 whether the client query 28 has any previously identified potential substitute queries. If yes, then the federation engine 12 may, at 212, randomly execute either the client query 28 or a potential substitute query. Statistics of the execution may be recorded at 218 and the result 30 of the executed query may be sent to the client 14 at 220. The client 14 may receive the result 30 at 222. If no potential substitute queries exist at 210, then the federation engine 12 may execute the query at 216, as described above. In some examples, the federation engine 12 may also transmit the complex query to the administrator system 18, as described herein.

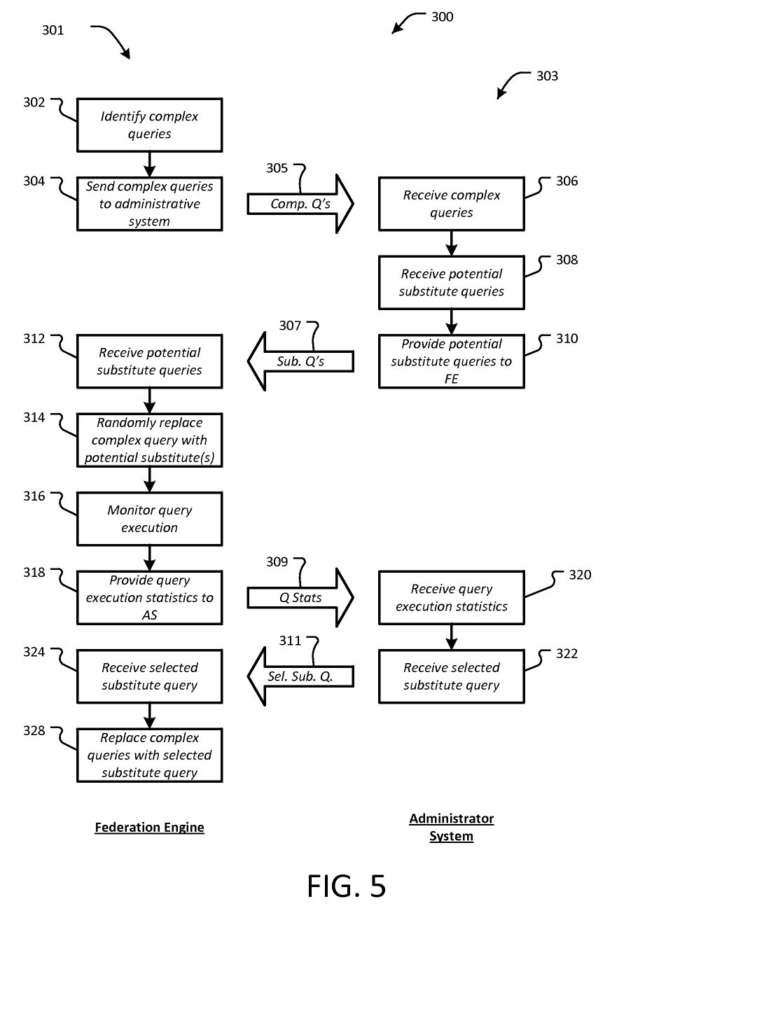

FIG. 5 is a flow chart showing one example of a process flow 300 that may be executed by the federation engine 12 and the administrator system 18 to optimize complex queries as described herein. The process flow 300 comprises a first column 301 showing actions that may be executed by the federation engine 12 and a second column 303 showing actions that may be executed by the administrator system 18. The process flow 300 shows one example way to execute portions of the process flow 100 described above. In some examples, the process flow 300 may be executed in parallel with the process flow 200 also described herein.

At 302, the federation engine 12 may identify complex queries, for example, as described herein with respect to 104 and 206. At 304, the federation engine 12 may send one or more identified complex queries 305 to the administrator system 18. The complex queries 305 may be transmitted in any suitable manner. For example, the complex queries 305 may be written to the query data store 16 at a location accessible to the administrator system 18. In some examples, the federation engine 12 may send a message to the administrator system 18, where the message includes the one or more complex queries. The administrator system 18 may receive the complex queries at 306. At 308, the administrator system 18 may receive one or more potential substitute queries. Each of the potential substitute queries may correspond to one of the complex queries 305. In some examples, some or all of the complex queries 305 may have multiple substitute queries. For example, an administrator may review the complex queries 305 and develop the potential substitute queries based on the complex queries 205 and the state of the various constituent data sources 20. At 310, the administrator system 18 may provide the potential substitute queries 307 to the federation engine 12, which may receive the potential substitute queries 307 at 312. At 314, the federation engine 12 may randomly replace subsequent instances of the complex queries 305 with a corresponding potential substitute query, as described herein. At 316, the federation engine 12 may monitor the execution of the potential substitute queries. At 318, the federation engine 12 may provide statistics 309 describing execution of the potential substitute queries to the administrator system 18, which may receive the statistics 309 at 320. The administrator system 18 may provide the statistics 309 to an administrator, who may select from the potential substitute queries for each complex query a selected query to be consistently used for subsequent instances of the original complex query. In some examples, the administrator system 18 and/or the federation engine 16 may be programmed to automatically pick a selected substitute query for one or more of the complex queries. For example, the potential substitute query with the lowest average execution time may be selected.

At 322, the administrator system may send the selected substitute queries 311 to the federation engine 12, which may receive them at 324. At 326, the federation engine 12 may replace instances of complex queries having selected substitute queries with the corresponding selected substitute query, for example, as described herein with respect to 200.

Reference in the specification to, “examples,” “various examples,” etc. means that a particular feature, structure, or characteristic described in connection with the examples is included in at least one example of the invention. The appearances of the above-referenced phrases in various places in the specification are not necessarily all referring to the same example. Reference to examples is intended to disclose examples, rather than limit the claimed invention. While the invention has been particularly shown and described with reference to several examples, it will be understood by persons skilled in the relevant art that various changes in form and details can be made therein without departing from the spirit and scope of the invention.

It should be noted that the language used in the specification has been principally selected for readability and instructional purposes, and may not have been selected to delineate or circumscribe the inventive subject matter. Accordingly, the present disclosure is intended to be illustrative, but not limiting, of the scope of the invention.

It is to be understood that the figures and descriptions of examples of the present disclosure have been simplified to illustrate elements that are relevant for a clear understanding of the present disclosure, while eliminating, for purposes of clarity, other elements, such as, for example, details of system architecture. Those of ordinary skill in the art will recognize that these and other elements may be desirable for practice of various aspects of the present examples. However, because such elements are well known in the art, and because they do not facilitate a better understanding of the present disclosure, a discussion of such elements is not provided herein.

It is to be understood that the figures and descriptions of examples of the present disclosure have been simplified to illustrate elements that are relevant for a clear understanding of the present disclosure, while eliminating, for purposes of clarity, other elements, such as, for example, details of system architecture. Those of ordinary skill in the art will recognize that these and other elements may be desirable for practice of various aspects of the present examples. However, because such elements are well known in the art, and because they do not facilitate a better understanding of the present disclosure, a discussion of such elements is not provided herein.

It can be appreciated that, in some examples of the present methods and systems disclosed herein, a single component can be replaced by multiple components, and multiple components replaced by a single component, to perform a given command or commands. Except where such substitution would not be operative to practice the present methods and systems, such substitution is within the scope of the present disclosure. Examples presented herein, including operational examples, are intended to illustrate potential implementations of the present method and system examples. It can be appreciated that such examples are intended primarily for purposes of illustration. No particular aspect or aspects of the example method, product, computer-readable media, and/or system examples described herein are intended to limit the scope of the present disclosure.

It will be appreciated that the various components of the environment 100 may be and/or be executed by any suitable type of computing device including, for example, desktop computers, laptop computers, mobile phones, palm top computers, personal digital assistants (PDA's), etc. As used herein, a “computer,” “computer system,” “computer device,” or “computing device,” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

Some portions of the above disclosure are presented in terms of methods and symbolic representations of operations on data bits within a computer memory. These descriptions and representations are the means used by those skilled in the art to most effectively convey the substance of their work to others skilled in the art. A method is here, and generally, conceived to be a sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality. It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present disclosure include process steps and instructions described herein in the form of a method. It should be noted that the process steps and instructions of the present disclosure can be embodied in software, firmware or hardware, and when embodied in software, can be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and systems presented herein, unless indicated otherwise, are not inherently related to any particular computer or other apparatus. Various general-purpose systems may also be used with programs in accordance with the teachings herein, or it may prove convenient to construct more specialized apparatus to perform the disclosed method actions. The structure for a variety of these systems will appear from the above description. In addition, although some of the examples herein are presented in the context of a particular programming language, the present disclosure is not limited to any particular programming language. It will be appreciated that a variety of programming languages may be used to implement the teachings of the present disclosure as described herein, and any references above to specific languages are provided for disclosure of enablement and best mode of the present disclosure.

The term “computer-readable medium” as used herein may include, for example, magnetic and optical memory devices such as diskettes, compact discs of both read-only and writeable varieties, optical disk drives, and hard disk drives. A computer-readable medium may also include non-transitory memory storage that can be physical or virtual.

We claim:

1. A system for managing a database comprising data from a source outside the database, the system comprising:
at least one processor programmed to execute a federation engine, wherein the federation engine is configured to:
receive, from a first client, a first client query;
process the first client query, wherein processing the first client query comprises sending a federation engine query to at least one constituent data source comprising a value for the data item;
determine that the first client query is a complex query, wherein determining that the first client query is a complex query comprises determining that a time to execute the first client query depends on a size of the constituent data source;
receive from an administrator system a plurality of potential substitute queries for the first client query;
receive a plurality of subsequent instances of the first client query;
process the plurality of subsequent instances of the first client query, wherein processing each of the plurality of subsequent instances of the first client query comprises:
randomly selecting a query from the group consisting of the plurality of potential substitute queries and the first client query; and
process the selected query; and
record data describing the execution of the selected query;
send to the administrator system data describing the processing of the plurality of subsequent instances of the first client query;
receiving, from the administrator system, a selected substitute query selected from the plurality of potential substitute queries;
receive from the at least one client an additional instance of the complex query; and
process the selected substitute query.

2. The system of claim 1, wherein processing the plurality of subsequent instances of the first client query comprises processing the complex query and each of the plurality of substitute queries about the same number of times.

3. The system of claim 1, wherein determining that the first client query is a complex client query comprises determining that the constituent data source exceeds a threshold size.

4. A system for managing a database comprising data from a source outside the database, the system comprising:
at least one processor programmed to execute a federation engine, wherein the federation engine is configured to:
receive from a first client a first client query, wherein the first client query references a data item stored at a constituent data source;
determine that the first client query is a complex client query; and
send the first client query to an administrator system.

5. The system of claim 4, wherein determining that the first client query is a complex client query comprises determining that a time to execute the first client query depends on a size of the constituent data source.

6. The system of claim 4, wherein determining that the first client query is a complex client query comprises determining that the constituent data source exceeds a threshold size.

7. The system of claim 4, wherein determining that the first client query is a complex client query comprises:
determining a size of the constituent data source;
selecting a complexity threshold based on the size of the constituent data source; and
determining whether the first client query exceeds the selected complexity threshold.

8. The system of claim 4, wherein the complexity threshold indicates an order of a dependence between an execution time of the first client query and the size of the constituent database.

9. The system of claim 4, wherein the federation engine is further configured to process the first client query, wherein processing the first client query comprises:
sending a federation engine query to the constituent data source;
receiving a reply to the federation engine query, the reply to the federation engine query comprising a value for the data item; and
send the first client a reply to the first client query, the reply to the first client query comprising the value for the data item.

10. The system of claim 4, wherein the federation engine is further configured to:
receive from an administrator system a plurality of potential substitute queries for the first client query;
receive a plurality of subsequent instances of the first client query;
process the plurality of subsequent instances of the first client query, wherein processing each of the plurality of subsequent instances of the first client query comprises:
randomly selecting a query from the group consisting of the plurality of potential substitute queries and the first client query; and
process the selected query; and
record data describing the execution of the selected query;
send to the administrator system data describing the processing of the plurality of subsequent instances of the first client query;
receiving, from the administrator system, a selected substitute query selected from the plurality of potential substitute queries;
receive from the at least one client an additional instance of the complex query; and
process the selected substitute query.

11. The system of claim 4, wherein the federation engine is further configured to:
determine that the first client query has an associated selected substitute query; and
process the selected substitute query.

12. The system of claim 4, wherein the federation engine is further configured to:
determine that the first client does not have an associated selected substitute query;
determine that the first client does have at least one associated potential substitute query;
randomly select a query from the group consisting of the first query and the at least one associated potential substitute query;
process the randomly selected query; and
provide data describing execution of the randomly selected query to the administrator system.

13. A method for managing a database comprising data from a source outside the database, the method comprising:
receiving, by a federation engine and from a first client, a first client query, wherein the first client query references a data item stored at a constituent data source;
determining, by the federation engine, that the first client query is a complex client query; and
sending, by the federation engine, the first client query to an administrator system.

14. The method of claim 13, wherein determining that the first client query is a complex client query comprises determining that a time to execute the first client query depends on a size of the constituent data source.

15. The method of claim 13, wherein determining that the first client query is a complex client query comprises determining that the constituent data source exceeds a threshold size.

16. The method of claim 13, wherein determining that the first client query is a complex client query comprises:
determining a size of the constituent data source;
selecting a complexity threshold based on the size of the constituent data source; and
determining whether the first client query exceeds the selected complexity threshold.

17. The method of claim 13, wherein the complexity threshold indicates an order of a dependence between an execution time of the first client query and the size of the constituent database.

18. The method of claim 13, further comprising processing the first client query, wherein processing the first client query comprises:
sending a federation engine query to the constituent data source;
receiving a reply to the federation engine query, the reply to the federation engine query comprising a value for the data item; and
send the first client a reply to the first client query, the reply to the first client query comprising the value for the data item.

19. The method of claim 13, further comprising:
receiving, by the federation engine and from an administrator system, a plurality of potential substitute queries for the first client query;
receiving, by the federation engine, a plurality of subsequent instances of the first client query;
processing, by the federation engine, the plurality of subsequent instances of the first client query, wherein processing each of the plurality of subsequent instances of the first client query comprises:
randomly selecting a query from the group consisting of the plurality of potential substitute queries and the first client query; and
process the selected query; and
record data describing the execution of the selected query;
sending, by the federation engine to the administrator system, data describing the processing of the plurality of subsequent instances of the first client query;
receiving, by the federation engine and from the administrator system, a selected substitute query selected from the plurality of substitute queries;
receiving, by the federation engine and from the at least one client an additional instance of the complex query; and
processing, by the federation engine, the selected substitute query.

20. The method of claim 13, further comprising:
determining, by the federation engine that the first client query has an associated selected substitute query; and
processing, by the federation engine, the selected substitute query.
